(19) United States
(12) Patent Application Publication
(10) Pub. No.: US 2012/0169547 A1
(43) Pub. Date: Jul. 5, 2012

(54) MULTIBAND ANTENNA WITH SURROUNDING CONDUCTIVE COSMETIC FEATURE

(75) Inventors: Sung-Hoon Oh, Cupertino, CA (US); Thomas Liu, Sunnyvale, CA (US); Thorsten Hertel, San Jose, CA (US); Joselito Gavilan, Sunnyvale, CA (US)

(73) Assignee: PALM, INC., Sunnyvale, CA (US)

(21) Appl. No.: 12/983,665

(22) Filed: Jan. 3, 2011

(51) Int. Cl. H01Q 1/24

(52) U.S. Cl. 343/702

(57) ABSTRACT

Various embodiments of an antenna structure for mobile devices are described. In one or more embodiments a multi-band antenna includes a multi-band antenna with a conductive cosmetic feature operating as a resonating element. In some embodiments, an antenna includes a folded monopole element, a loop element formed between a portion of the conductive cosmetic feature and the printed circuit board and an L-shaped slot antenna element defined in part by a side surface of the conductive cosmetic feature. In some embodiments the folded monopole element, the loop element, and the slot antenna element are capable of resonating in response to a signal applied to the folded monopole element. Other embodiments are described and claimed.

### BACKGROUND

A mobile computing device such as a combination handheld computer and mobile telephone or smart phone generally may provide voice and data communications functionality, as well as computing and processing capabilities. Such mobile computing devices rely on antenna designs that are severely constrained by space, volume and other mechanical limitations. Such constraints result in less than desired performance. Accordingly, there may be a need for an improved antenna for use with mobile computing devices. Such an improved antenna should provide good efficiency and gain patterns and should satisfy space, volume, product design and mechanical constraints associated with modern handset architectures. The improved antenna should be a simple and low-profile structure for mobile handsets, and should enable wide band frequency response and a unique antenna pattern without compromising antenna size or efficiency.

### BRIEF DESCRIPTION OF THE DRAWINGS

FIG. 1 illustrates a housing for a mobile computing device in accordance with one or more embodiments.

FIG. 2 illustrates a housing for a mobile computing device in accordance with one or more embodiments.

FIG. 3 is an isometric view of a position of an antenna element with respect to a PCB board and mobile computing device housing according to one or more embodiments.

FIG. 4 illustrates a position of an antenna element with respect to a PCB board and mobile computing device housing according to one or more embodiments.

FIG. 5 illustrates a position of an antenna element with respect to a PCB board and mobile computing device housing according to one or more embodiments.

FIG. 6 illustrates a position of an antenna element with respect to a PCB board and mobile computing device housing according to one or more embodiments.

FIG. 7 illustrates a matching circuit in accordance with one or more embodiments.

FIG. 8 illustrates a frequency plot representative of one or more embodiments.

FIGS. 9A and 9B illustrate an exemplary tuning arrangement with respect to a PCB board and mobile computing device housing according to one or more embodiments.

FIG. 10 is a frequency plot representative of one or more embodiments of a tuning arrangement.

FIG. 11 is a frequency plot representative of one or more embodiments of a tuning arrangement.

FIG. 12 illustrates a system in accordance with one or more embodiments.

### DETAILED DESCRIPTION

Current and next-generation wireless mobile devices use wide-band and multi-band antennas. Due to fundamental gain-bandwidth limitations of antennas of limited size, however, antenna structure poses a limit to ever shrinking and ever complicated mobile device designs. Moreover, when designing antennas for mobile devices, avoiding complicated antenna structures may be desirable in order to reduce engineering costs, cycle times, and product reliability issues. In addition, product design considerations also may impact device architecture. For example, some thin profile devices include a conductive cosmetic feature around the perimeter of the device housing. While providing an attractive appearance, such conductive cosmetic features can cause interference with the device's antenna system. A multi-band antenna solution is, therefore, disclosed which employs the conductive cosmetic feature as a radiating structure. The disclosed arrangement enables implementation of a conductive cosmetic feature around a thin wireless device, taking advantage of the properties of the conductive cosmetic feature as a resonating element rather than trying to mitigate the conductive cosmetic feature's interfering effects.

A multi-band antenna is disclosed having a simple, low-profile structure for use in mobile devices. The antenna enables wide band frequency response without compromising antenna size and system efficiency. Various embodiments are directed to a multi-band antenna with a conductive cosmetic feature operating as a resonating element. In some embodiments, an antenna includes a folded monopole element, a loop element surrounding the folded monopole element, and a slot antenna element. Both the loop element and the slot element are defined in part by a side surface of the conductive cosmetic feature. In some embodiments the folded monopole element, the loop, and the slot antenna element are capable of resonating in response to a signal applied to the folded monopole element.

In some embodiments a mobile computing device includes an applications processor, a radio processor, a display, and an antenna. In some embodiments the antenna comprises a folded monopole element coupled to a signal feed, a loop element, and a slot antenna element disposed adjacent to the conductive cosmetic feature. In some embodiments, for high band operation, the folded monopole element, the loop element, and the slot antenna element may be capable of resonating at first, second and third frequencies in response to a signal applied to the folded monopole element via the signal feed. In other embodiments an antenna comprises a folded monopole element coupled to a signal feed, a loop element surrounding said folded monopole element, and a slot antenna element formed between an inner side surface of the conductive cosmetic feature and a side of a printed circuit board. In some embodiments the folded monopole element, the loop element, and the slot antenna element are configured to resonate at different frequencies in response to a signal applied to the folded monopole element.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be merely representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

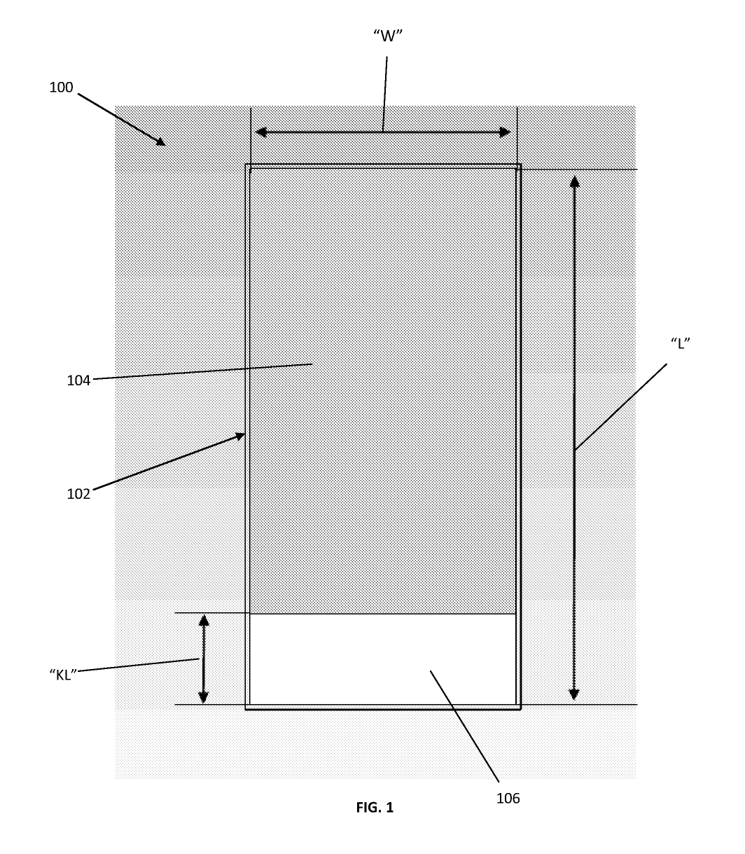

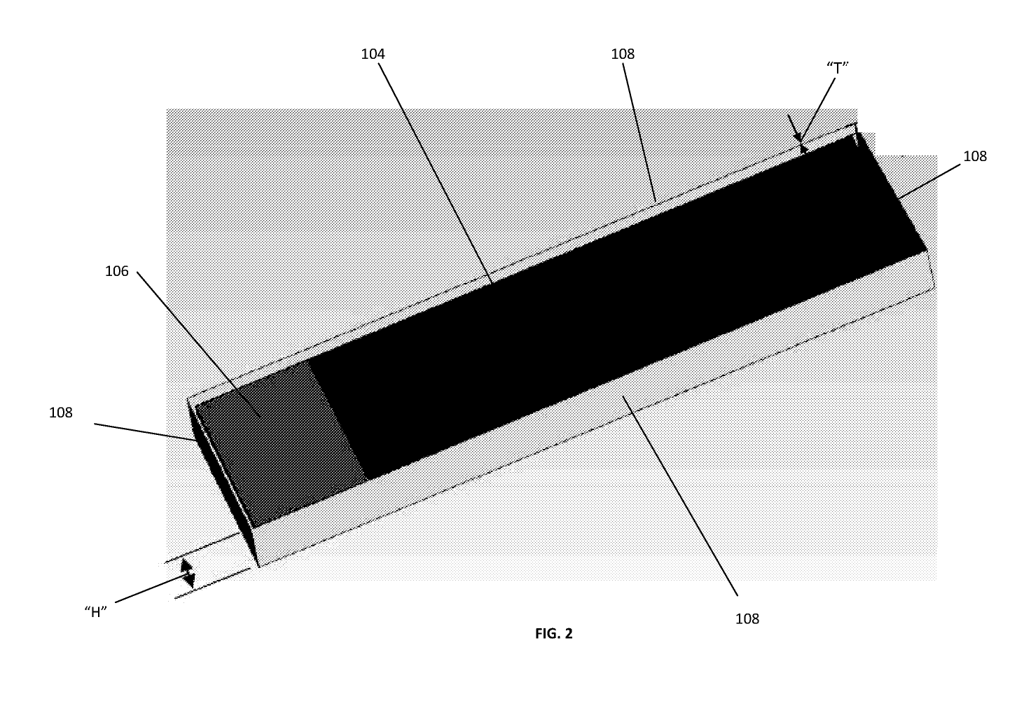

FIGS. 1 and 2 illustrate an embodiment of a wireless device 100. The wireless device 100 may comprise, or be implemented as, a handheld computer, mobile telephone, personal digital assistant (PDA), combination cellular telephone/PDA, data transmission device, one-way pager, two-way pager, and so forth. Although some embodiments may be described with the wireless device 100 implemented as a handheld computer by way of example, it may be appreciated that other embodiments may be implemented using other wireless handheld devices as well.

In various embodiments, the wireless device 100 may comprise a housing 102 and a printed circuit board (PCB) 104. The housing 102 may include one or more materials such as plastic, metal, ceramic, glass, and so forth, suitable for enclosing and protecting the internal components of the wireless device 100. The PCB 104 may comprise materials such as FR4, Rogers R04003, and/or Roger RT/Duroid, for example, and may include one or more conductive traces, via structures, and/or laminates. The PCB 104 also may include a finish such as Gold, Nickel, Tin, or Lead. In various implementations, the PCB 104 may be fabricated using processes such as etching, bonding, drilling, and plating.

The device 100 may include a “keep-out” area 106 at or near one end of the housing 102. The keep-out area 106 comprises a region of the device housing 102 that the PCB does not occupy. In the disclosed embodiments, however, the “keep-out” area 106 may house an internal antenna structure. As will be discussed in greater detail later, the size and arrangement of the disclosed antenna structure is constrained by the size of the keep-out area 106, and thus it is desirable that the antenna structure provide a desired performance in as small a form factor as practical.

The housing 102 may have a width “W,” a length “L,” and a height “H.” At least a portion of the perimeter of the housing 102 may comprise a conductive cosmetic feature 108. In some embodiments, the conductive cosmetic feature 108 may be disposed about the entire perimeter of the housing 102. In other embodiments, the conductive cosmetic feature 108 may be disposed about less than the entire perimeter. As illustrated, the conductive cosmetic feature 108 may have a thickness “T.”

In one non-limiting exemplary embodiment, width “W” may be about 55 millimeters, the length “L” may be about 110 mm, the height “H” may be about 5 mm, and the thickness “T” may be about 1 mm. It will be appreciated that for embodiments in which the perimeter of the housing 102 is formed by the conductive cosmetic feature 108, the conductive cosmetic feature will have these dimensions. In some embodiments, the keep-out area 106 may have a length “KL” of about 20 mm.

In some embodiments the conductive cosmetic feature108 may be formed from copper, aluminum, stainless steel, silver, or combinations thereof. It will be appreciated that other materials may also be used as desired.

In various embodiments, a wireless device 100 may comprise elements such as a display, an input/output (I/O) device, a processor, a memory, and a transceiver, for example. One or more elements may be implemented using one or more circuits, components, registers, processors, software subroutines, modules, or any combination thereof, as desired for a given set of design or performance constraints.

The display may be implemented using any type of visual interface such as a liquid crystal display (LCD), a touch-sensitive display screen, and so forth. The I/O device may be implemented, for example, using an alphanumeric keyboard, a numeric keypad, a touch pad, input keys, buttons, switches, rocker switches, a stylus, and so forth. The embodiments are not limited in this context.

The processor may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In some embodiments, for example, the processor may be implemented as a general purpose processor, such as a processor made by Intel® Corporation, Santa Clara, Calif. The processor also may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments, however, are not limited in this context.

The memory may be implemented using any machine-readable or computer-readable media capable of storing data, including both volatile and non-volatile memory. The memory may be non-transient computer-readable media (e.g., memory or storage). Memory may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory may be included on the same integrated circuit as a processor, or alternatively some portion or all of memory may be disposed on an integrated circuit or other medium, for example a hard disk drive, that is external to the integrated circuit of a processor. The embodiments are not limited in this context.

The transceiver may be implemented, for example, by any transceiver suitable for operating at a given set of operating frequencies and wireless protocols for a particular wireless system. For example, the transceiver may be a two-way radio transceiver arranged to operate in the 824-894 MHz frequency band (GSM), the 1850-1990 MHz frequency band (PCS), the 1575 MHz frequency band (GPS), the 824-894 MHz frequency band (NAMPS), the 1710-2170 MHz frequency band (WCDMA/UMTS), or other frequency bands.

In various embodiments, an antenna may be electrically connected to a transceiver operatively associated with a signal processing circuit or processor positioned on a PCB. In order to increase power transfer, the transceiver may be interconnected to an antenna such that respective impedances are substantially matched or electrically tuned to compensate for undesired antenna impedance. In some cases, the transceiver may be implemented as part of a chip set associated with a processor. The embodiments are not limited in this context.

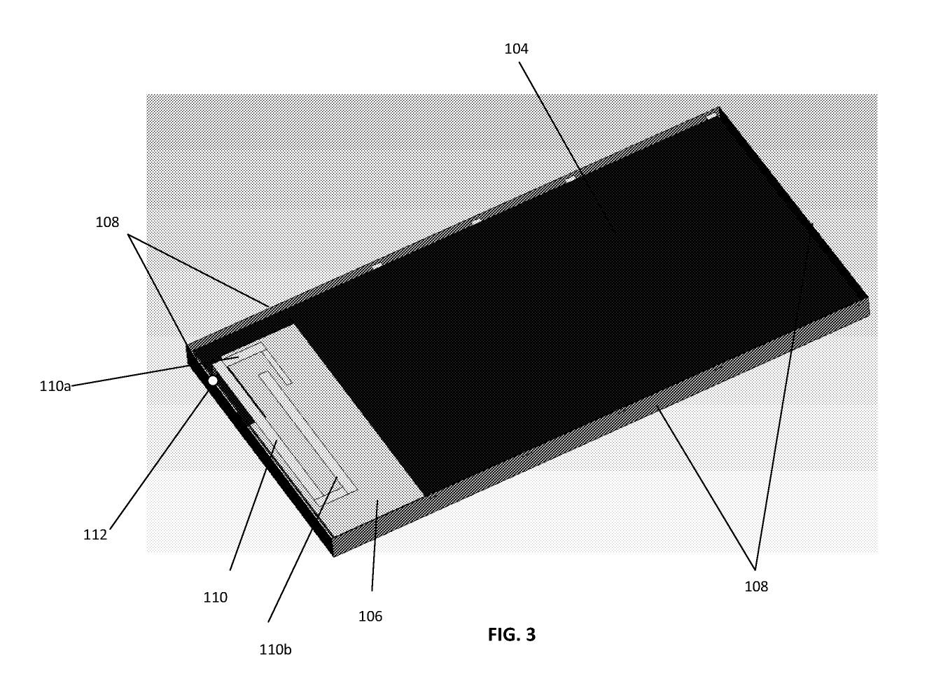

Referring to FIG. 3, an antenna structure 110 of device 100 is shown disposed in the keep-out area 106 adjacent the PCB 104. In the illustrated embodiment, the antenna structure 110 is a folded monopole antenna comprising resonating elements, or “arms” 110a, 110b which in operation may resonate at a desired frequency or frequencies. It will be appreciated that the illustrated monopole antenna is exemplary, and that the antenna structure 110, including arms 110a, 110b, can have a variety of other shapes as desired. As will be described in greater detail later, the antenna structure 110 may have a feed point 112 disposed adjacent to one end of the conductive cosmetic feature 108.

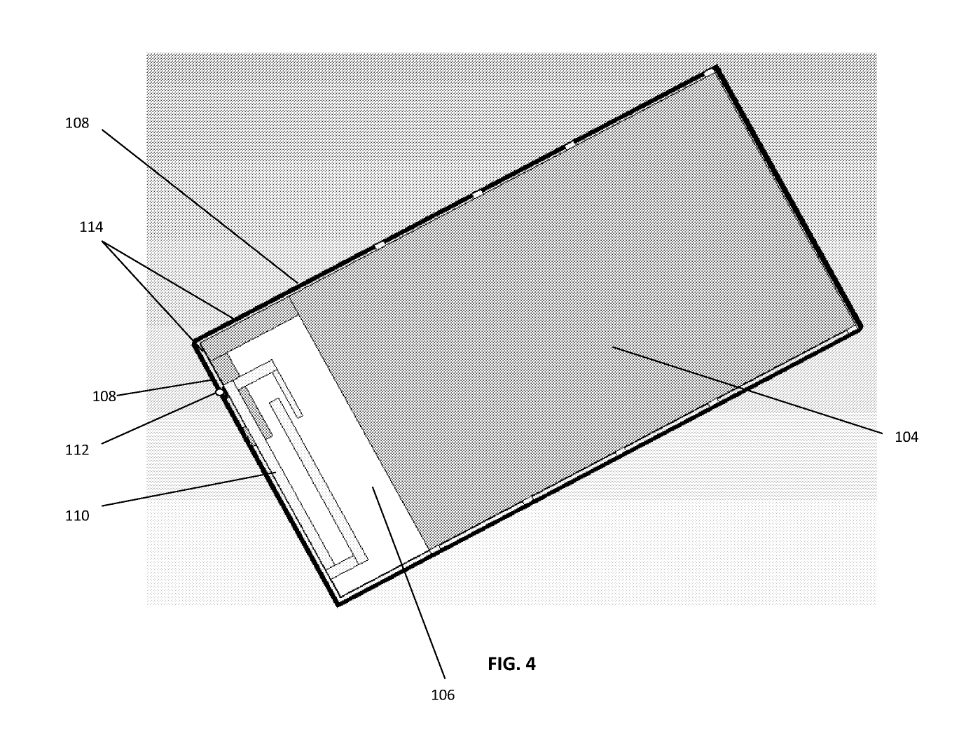

In some embodiments, a slot antenna element 114 may be provided adjacent to the folded monopole antenna structure 110 in order to enhance an overall bandwidth of the device 100. FIGS. 4-6 show an exemplary slot antenna element 114 having an L-shape formed at a corner of the conductive cosmetic feature 108. The slot antenna element 114 is formed as a gap between the conductive cosmetic feature 108 and the PCB 104. This gap can be left open, or it may be filled with dielectric material. In operation, the slot antenna element 114 provides a slot mode resonance which may be different from the resonance of the antenna structure 110, thus resulting in a wider overall bandwidth for the device 100.

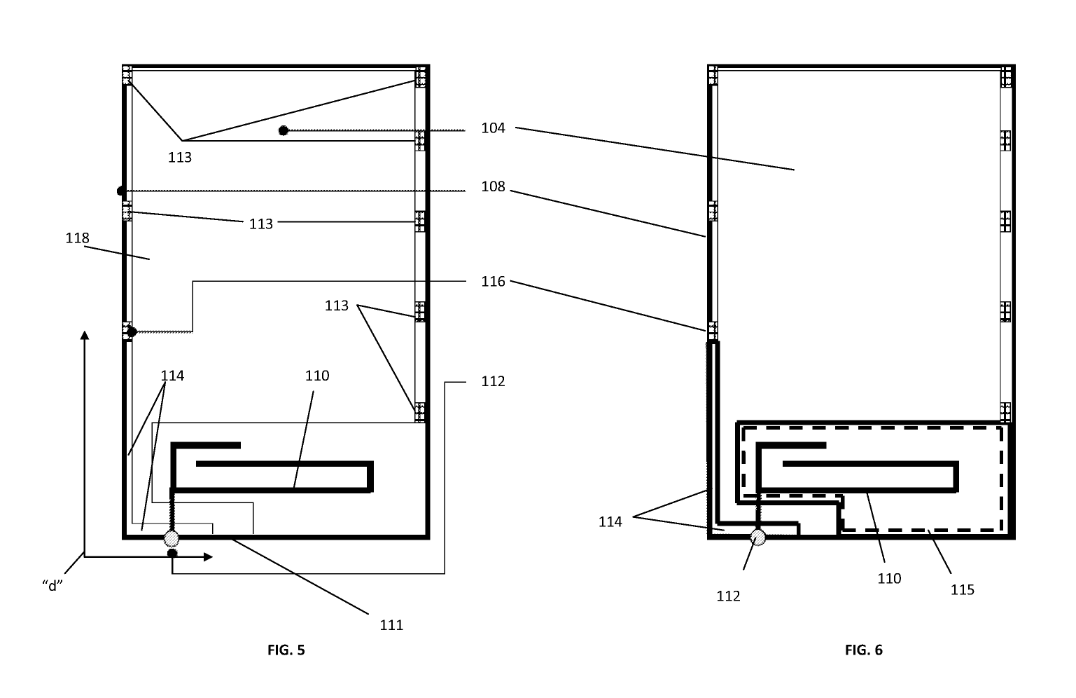

The resonance mode of the slot antenna element 114 may be tuned by adjusting the distance “d” between a bottom edge 111 of the slot and the slot ground point 116 (FIG. 5) of the conductive cosmetic feature 108. In the embodiment illustrated in FIG. 5, the conductive cosmetic feature 108 is connected to the PCB 104 at multiple ground points 113. It will be appreciated, however, that the positioning of the slot ground point 116 and multiple ground points 113 is exemplary and other ground point positions may be employed. As noted, the folded monopole antenna structure 110 may be directly fed by an antenna feed 112 at a position adjacent to one end of the conductive cosmetic feature 108. In the illustrated embodiment, the antenna feed 112 is located near an end of the conductive cosmetic feature 108 positioned adjacent to the antenna structure 110. Positioning the antenna feed 112 near an end of the conductive cosmetic feature 108 may enhance device performance. In addition, the slot antenna element 114 may be effectively excited by locating the feed 112 in this manner. In some embodiments, the antenna feed 112 may be a coaxial cable connection, a microstrip line, a slot line, a coplanar waveguide, a parallel transmission line, or the like. The antenna feed 112 may be coupled to an appropriate impedance matching circuit which, in turn, may be coupled to an associated transceiver. Referring to FIG. 6, a loop element 115 (shown in dashed lines) is formed as a space between the conductive cosmetic feature 108 and the PCB 104. The loop element 115 surrounds the folded monopole antenna element 110, and is configured to generate a loop resonance mode. Excitation of the loop 115 is achieved via a capacitive coupling from the folded monopole arms.

As will be understood, the antenna feed 112 causes the folded monopole 110 to resonate at a first high band frequency. This, in turn, causes the loop 115 formed between the conductive cosmetic feature 108 and the PCB 104 to resonate at a second high band frequency, and additionally causes the slot antenna element 114 to resonate at a third high band frequency. For the illustrated arrangement, all three elements may resonate at a different frequency, thereby providing the device 100 with an enhanced bandwidth as compared to prior designs.

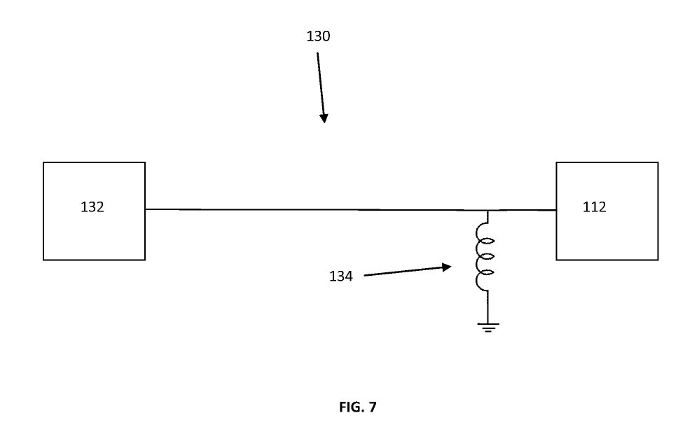

FIG. 7 shows an exemplary matching circuit 130 for use with the disclosed monopole antenna structure 110. The matching circuit 130 may couple the antenna feed 112 to an output from a transceiver 132, and may include one or more components useful for matching the impedance of the transceiver to the impedance of the antenna over a wide frequency range. In the illustrated embodiment, the matching circuit 130 may include an inductor coupled in parallel with the antenna feed 112. In one non-limiting exemplary embodiment, the inductor 134 may have an inductance of 8 nanoHenrys (nH). It will be appreciated that this is but one exemplary implementation of a matching circuit 130, and others may also be used.

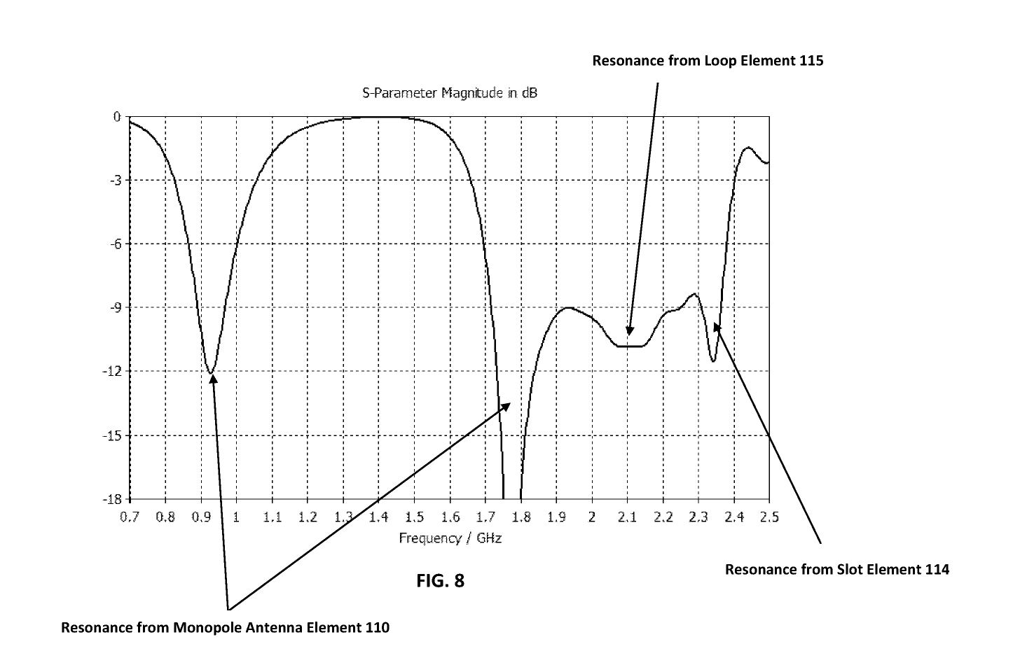

FIG. 8 shows a frequency plot relating to embodiments of the disclosed antenna arrangement of device 100. As can be seen, the disclosed arrangement may result in a plurality of separate resonances. First and second resonances may be produced by the folded monopole antenna structure 110, a third resonance may be produced by the loop 115, and a fourth resonance may be produced by the L-shaped slot 114. In the illustrated embodiment, the first resonance may be about 0.9 GHz, the second resonance may be about 1.8 GHz, the third resonance may be about 2.1 GHz, and the fourth resonance may be about 2.35 GHz. It will be appreciated that these values are exemplary, and that for some embodiments other resonance values may be produced.

The above-described arrangement of resonating elements (i.e., the monopole element 110, the loop 115, and the slot 114) may thus provide the device 100 with an operational range of from about 1.7 GHz to about 2.4 GHz. It will be appreciated that this is an exemplary operating range. It will be appreciated that the antenna structure 110, the loop 115 created by the conductive cosmetic feature 108 and PCB, and the slot 114 can be provided in a variety of different size, shape and arrangement combinations to result in other desired resonance values and/or ranges.

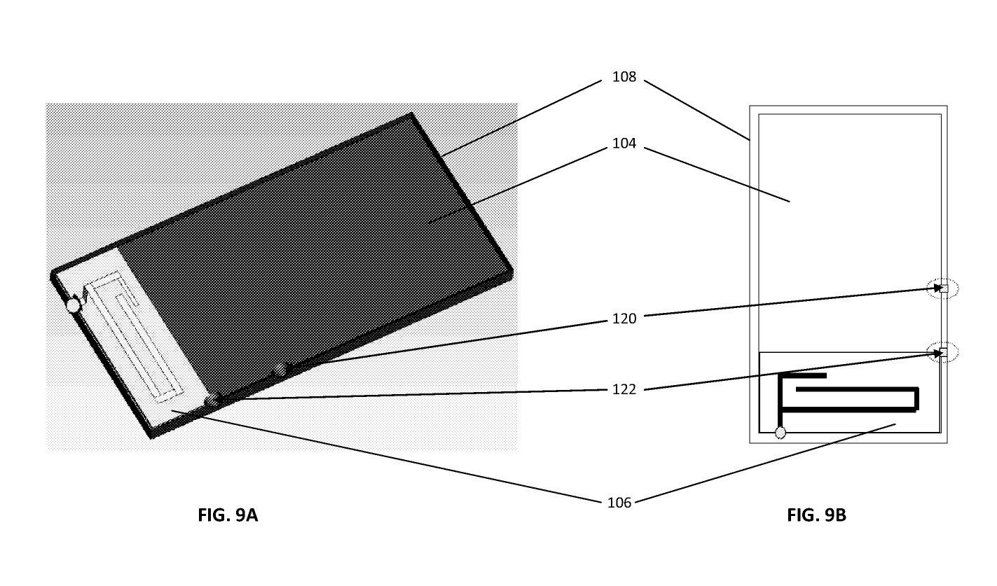

Since the size and shape of the conductive cosmetic feature 108 may be defined by the form factor of the device 100 (i.e., the conductive cosmetic feature's size and shape may be dictated by product design rather than device performance consideration), it may be desirable to tune the conductive cosmetic feature 108 so that it will resonate at one or more predetermined frequencies. FIGS. 9A and 9B show an exemplary embodiment in which a lumped capacitance arrangement is provided to facilitate tuning the conductive cosmetic feature 108. In the illustrated embodiment, first and second lumped capacitive elements 120, 122 are provided on one side of the conductive cosmetic feature 108. It will be appreciated that the illustrated tuning arrangement is exemplary, and that any of a variety of alternative tuning arrangements can also be used. The first and second lumped capacitive elements 120, 122 may have different capacitances, or they may have the same capacitance. In addition, greater or fewer numbers of capacitors may be provided. In one exemplary, non-limiting embodiment, the first and second capacitive elements 120, 122 may have capacitances of from about 2 picofarads (pF) to about 5 pF.

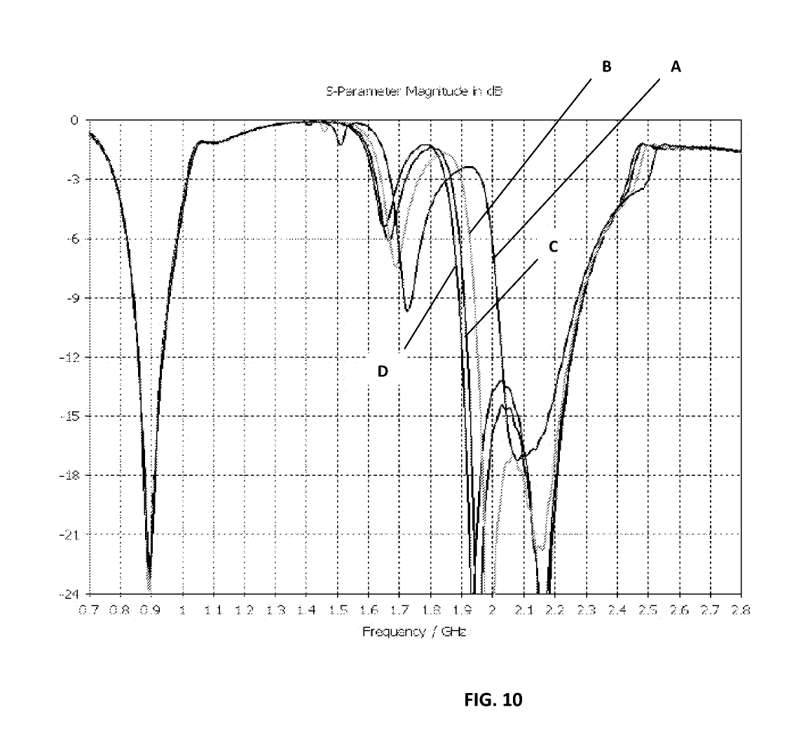

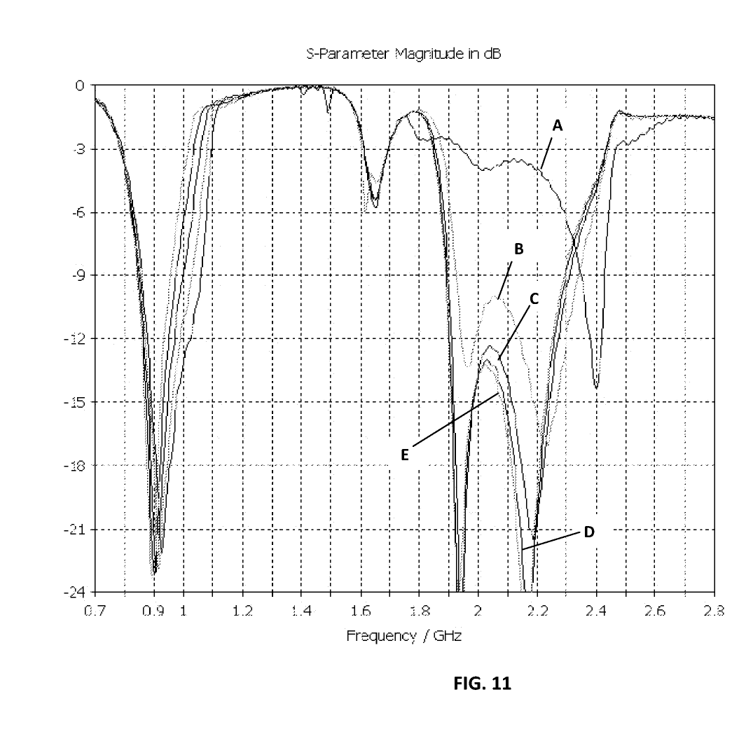

FIGS. 10 and 11 illustrate the effect that different combinations of capacitive loading on the conductive cosmetic feature 108 may have on the resonance of the folded monopole antenna 110. As can be seen, these plots show that the conductive cosmetic feature 108 can be tuned by an array of capacitive loading elements. Thus, FIG. 10 shows the effect on folded monopole antenna resonance where capacitive element 120 is varied between 2 pF and 5 pF, while capacitive element 122 is fixed at 5 pf. Namely, curve “A” illustrates a frequency response resulting from the combination of the folded monopole antenna and the conductive cosmetic feature 108 tuned by capacitive loading elements, where element 120 is 2 pF and element 122 is 5 pF, curve “B” illustrates frequency response where element 120 is 3 pF and element 122 is 5 pF, curve “C” illustrates frequency response where element 120 is 4 pF and element 122 is 5 pF, and curve “D” illustrates frequency response where element 120 is 5 pF and element 122 is 5 pF.

FIG. 11 shows the effect of the capacitive loading on the conductive cosmetic feature 108 may have on the resonance on the folded monopole antenna 110 where the first capacitive element 120 is fixed at 5 pF, while the second capacitive element is varied between 2 pF and 5 pF. Namely, curve “A” illustrates a frequency response resulting from the combination of the folded monopole antenna and the conductive cosmetic feature 108 tuned by capacitive loading elements, where element 120 is 5 pF and element 122 is 1 pF, curve “B” illustrates folded monopole antenna resonance where element 120 is 5 pF and element 122 is 2 pF, curve “C” illustrates frequency response where element 120 is 5 pF and element 122 is 3 pF, curve “D” illustrates frequency response where element 120 is 5 pF and element 122 is 4 pF, and curve “E” illustrates frequency response where element 120 is 5 pF and element 122 is 5 pF.

It will be appreciated that the described capacitance arrangements are merely exemplary, and that others may also be used to achieve a desired resonance of folded monopole antenna due to the capacitive loading conductive cosmetic feature 108.

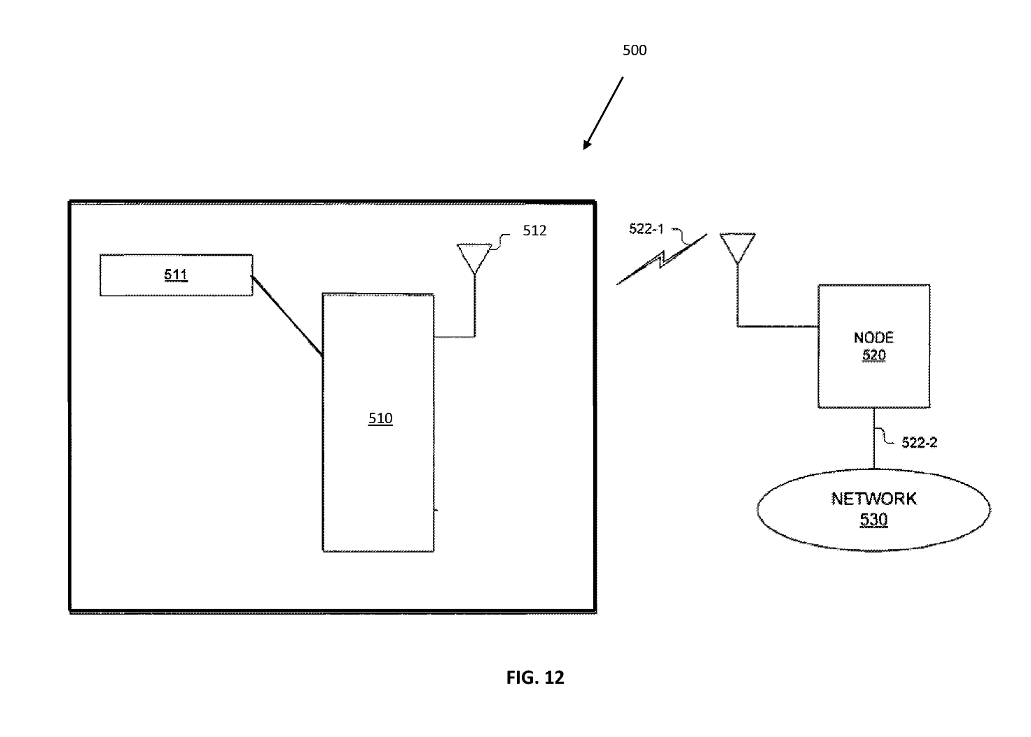

FIG. 12 illustrates one embodiment of a communications system 500 having multiple nodes. A node may comprise any physical or logical entity for communicating information in the communications system 500 and may be implemented as hardware, software, or any combination thereof, as desired for a given set of design parameters or performance constraints. Although FIG. 12 is shown with a limited number of nodes in a certain topology, it may be appreciated that communications system 500 may include more or less nodes in any type of topology as desired for a given implementation. The embodiments are not limited in this context.

In various embodiments, a node may comprise a processing system, a computer system, a computer sub-system, a computer, a laptop computer, an ultra-laptop computer, a portable computer, a handheld computer, a PDA, a cellular telephone, a combination cellular telephone/PDA, a microprocessor, an integrated circuit, a PLD, a DSP, a processor, a circuit, a logic gate, a register, a microprocessor, an integrated circuit, a semiconductor device, a chip, a transistor, and so forth. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a processor, and so forth. The embodiments are not limited in this context.

Communications system 500 may be implemented as a wired communication system, a wireless communication system, or a combination of both. Although system 500 may be illustrated using a particular communications media by way of example, it may be appreciated that the principles and techniques discussed herein may be implemented using any type of communication media and accompanying technology. The embodiments are not limited in this context.

When implemented as a wired system, for example, communications system 500 may include one or more nodes arranged to communicate information over one or more wired communications media. Examples of wired communications media may include a wire, cable, PCB, backplane, switch fabric, semiconductor material, twisted-pair wire, co-axial cable, fiber optics, and so forth. The communications media may be connected to a node using an I/O adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, for example, system 500 may include one or more wireless nodes arranged to communicate information over one or more types of wireless communication media, sometimes referred to herein as wireless shared media. An example of a wireless communication media may include portions of a wireless spectrum, such as the radio-frequency (RF) spectrum. The wireless nodes may include components and interfaces suitable for communicating information signals over the designated wireless spectrum, such as one or more antennas, wireless transceivers, amplifiers, filters, control logic, and so forth. As used herein, the term “transceiver” may be used in a very general sense to include a transmitter, a receiver, or a combination of both. The embodiments are not limited in this context.

As shown, the communications system 500 may include a wireless node 510. In various embodiments, the wireless node 510 may be implemented as a wireless device such as wireless device 100. Examples of wireless node 510 also may include any of the previous examples for a node as previously described.

In one embodiment, for example, the wireless node 510 may comprise a receiver 511 and an antenna 512. The receiver 511 may be implemented, for example, by any suitable receiver for receiving electrical energy in accordance with a given set of performance or design constraints as desired for a particular implementation. In various embodiments, the antenna 512 may be similar in structure and operation the antenna structures described in relation to FIGS. 1-11. In some implementations, the antenna 512 may be configured for reception as well as transmission.

In various embodiments, the communications system 500 may include a wireless node 520. Wireless node 520 may comprise, for example, a mobile station or fixed station having wireless capabilities. Examples for wireless node 520 may include any of the examples given for wireless node 510, and further including a wireless access point, base station or node B, router, switch, hub, gateway, and so forth. In one embodiment, for example, wireless node 520 may comprise a base station for a cellular radiotelephone communications system. Although some embodiments may be described with wireless node 520 implemented as a base station by way of example, it may be appreciated that other embodiments may be implemented using other wireless devices as well. The embodiments are not limited in this context.

Communications between the wireless nodes 510, 520 may be performed over wireless shared media 522-1 in accordance with a number of wireless protocols. Examples of wireless protocols may include various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may include various WWAN protocols, such as GSM cellular radiotelephone system protocols with GPRS, CDMA cellular radiotelephone communication systems with 1xRTT, EDGE systems, EV-DO systems, EV-DV systems, HSDPA systems, and so forth. Further examples of wireless protocols may include wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may include near-field communication techniques and protocols, such as electromagnetic induction (EMI) techniques. An example of EMI techniques may include passive or active radio-frequency identification (RFID) protocols and devices. Other suitable protocols may include Ultra Wide Band (UWB), Digital Office (DO), Digital Home, Trusted Platform Module (TPM), ZigBee, and other protocols. The embodiments are not limited in this context.

In one embodiment, wireless nodes 510, 520 may comprise part of a cellular communication system. Examples of cellular communication systems may include Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) systems such as Wide-band CDMA (WCDMA), CDMA-2000, Universal Mobile Telephone System (UMTS) cellular radiotelephone systems compliant with the Third-Generation Partnership Project (3GPP), and so forth. The embodiments are not limited in this context.

In addition to voice communication services, the wireless nodes 510, 520 may be arranged to communicate using a number of different wireless wide area network (WWAN) data communication services. Examples of cellular data communication systems offering WWAN data communication services may include a GSM with General Packet Radio Service (GPRS) systems (GSM/GPRS), CDMA/1xRTT systems, Enhanced Data Rates for Global Evolution (EDGE) systems, Evolution Data Only or EVDO systems, Evolution for Data and Voice (EV-DV) systems, High Speed Downlink Packet Access (HSDPA) systems, and so forth. The embodiments are not limited in this respect.

In one embodiment, the communication system 500 may include a network 530 connected to the wireless node 520 by wired communications medium 522-2. The network 530 may comprise additional nodes and connections to other networks, including a voice/data network such as the Public Switched Telephone Network (PSTN), a packet network such as the Internet, a local area network (LAN), a metropolitan area network (MAN), a wide area network (WAN), an enterprise network, a private network, and so forth. The network 530 also may include other cellular radio telephone system equipment, such as base stations, mobile subscriber centers, central offices, and so forth. The embodiments are not limited in this context.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

Various embodiments may comprise one or more elements. An element may comprise any structure arranged to perform certain operations. Each element may be implemented as hardware, software, or any combination thereof, as desired for a given set of design and/or performance constraints. Although an embodiment may be described with a limited number of elements in a certain topology by way of example, the embodiment may include more or less elements in alternate topologies as desired for a given implementation.

Any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, API, exchanging messages, and so forth.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. An antenna, comprising:
a folded monopole element;
a loop element surrounding the folded monopole element; and
a slot antenna element defined in part by a side surface of a conductive cosmetic feature;
wherein the folded monopole element, the loop element, and the slot antenna element are capable of resonating in response to a signal applied to the folded monopole element.

2. The antenna of claim 1, comprising a signal feed coupled to the folded monopole element.

3. The antenna of claim 2, the signal feed disposed at one end of the conductive cosmetic feature.

4. The antenna of claim 1, the loop element formed by a portion of a mobile communication device housing.

5. The antenna of claim 1, the folded monopole element, the loop element, and the slot antenna element capable of resonating at first, second and third frequencies for high band operation.

6. The antenna of claim 5, the first, second and third frequencies being different from each other.

7. The antenna of claim 1, the slot antenna element having an L-shape disposed adjacent to a corner portion of the conductive cosmetic feature.

8. The antenna of claim 7, the slot antenna element at least partially defined by a side surface of a printed circuit board of a mobile communication device.

9. The antenna of claim 1, comprising a ground point electrically coupling the conductive cosmetic feature to a ground plane portion of a printed circuit board.

10. The antenna of claim 1, comprising a capacitor electrically coupled with the conductive cosmetic feature.

11. A mobile computing device, comprising:
an applications processor, a radio processor, a display, and an antenna, the antenna comprising:
a folded monopole element coupled to a signal feed;
a loop element; and
a slot antenna element adjacent to a conductive cosmetic feature;
wherein the folded monopole element, the loop element, and the slot antenna element are capable of resonating at first, second and third frequencies in response to a signal applied to the folded monopole element via the signal feed.

12. The device of claim 11, the conductive cosmetic feature comprising a metal ring substantially surrounding the folded monopole element and forming a portion of the loop element and the slot antenna element.

13. The device of claim 11, the loop element formed in part by a side wall of the mobile computing device.

14. The device of claim 11, the first, second and third frequencies being different from each other for high band operation.

15. The device of claim 11, the slot antenna element comprising an L-shaped slot formed between an inner side surface of the conductive cosmetic feature and a side surface of a printed circuit board of the mobile computing device.

16. The device of claim 11, comprising a ground point electrically coupling the conductive cosmetic feature to a ground plane portion of a printed circuit board.

17. The device of claim 11, the folded monopole element fed via the signal feed at one end of the conductive cosmetic feature.

18. An antenna, comprising:
a folded monopole element coupled to a signal feed;
a loop element surrounding said folded monopole element; and
a slot antenna element formed between an inner side surface of a conductive cosmetic feature and a side surface of a printed circuit board;
wherein the folded monopole element, the loop element, and the slot antenna element are configured to resonate at different frequencies in response to a signal applied to the folded monopole element.

19. The antenna of claim 18, comprising a single ground point electrically coupling the conductive cosmetic feature to a ground plane portion of the printed circuit board, the signal feed coupled to the folded monopole element at one end of the conductive cosmetic feature.

20. The antenna of claim 18, the slot antenna element comprising an L-shaped slot disposed at a corner of the conductive cosmetic feature adjacent to the folded monopole element.
